(19) United States
(12) Patent Application Publication
(10) Pub. No.: US 2026/0043218 A1
(43) Pub. Date: Feb. 12, 2026

(54) WATER DISPENSING FIXTURE AND FILTER ACCESS FOR SAME

(71) Applicant: EMC Water LLC, Downers Grove, IL (US)

(72) Inventors: Jonathan Chong, Palatine, IL (US); Jason Silverstein, Palatine, IL (US); Samuel Goodrow, Dublin, OH (US); Michael Grady, Chicago, IL (US)

(21) Appl. No.: 19/193,268

(22) Filed: Apr. 29, 2025

Related U.S. Application Data
(60) Provisional application No. 63/679,926, filed on Aug. 6, 2024.
(60) Provisional application No. 63/703,719, filed on Oct. 4, 2024.

(51) Int. Cl. E03B 9/20; B01D 29/96; B01D 35/04; C02F 1/00

(52) U.S. Cl. CPC E03B 9/20; B01D 29/96; B01D 35/04; C02F 1/003; C02F 2307/10

(57) ABSTRACT

A liquid dispenser station includes a liquid dispenser configured to dispense liquid that passes through a filter. The filter is disposed within the liquid dispenser station. The liquid dispenser has an access door to provide access to the filter. The filter includes a key to open the access door.

### CROSS-REFERENCE TO RELATED APPLICATIONS

The present application claims the benefit of prior-filed, co-pending U.S. Provisional Ser. No. 63/679,926 , filed Aug. 6, 2024, and U.S. Provisional Ser. No. 63/703,719, filed Oct. 4, 2024. The entire contents of these applications are incorporated herein by reference.

### TECHNICAL FIELD

The present application relates to a water dispensing fixture, and particularly to a filter access for a water dispensing fixture.

### BACKGROUND

Bottle fillers dispense liquid (e.g., water) to a container. A bottle filler may include a filter to remove contaminants and impurities before the water is dispensed. The filter may be replaced periodically.

### SUMMARY

In one independent aspect, a liquid dispensing system includes a frame; a liquid dispensing spigot supported on the frame; a drain supported on the frame; and at least one filter supported on the frame, the at least one filter positioned in an upper portion of the frame and configured to provide unobstructed visibility of the at least one filter to a user to facilitate access to the filter.

In some aspects, the at least one filter is spaced apart from a ground surface by between 27 inches and 72 inches.

In some aspects, the liquid dispensing system further includes a service cover coupled to the frame, the service cover selectively movable to permit access to the at least one filter.

In some aspects, a peripheral end of the service cover is coupled to the upper portion of the frame, the service cover pivotable about a rotational axis oriented parallel to a direction extending laterally between a first side of the frame and a second side of the frame.

In some aspects, the service cover is pivotable about the rotational axis in a direction away from the upper portion of the frame and toward the drain.

In some aspects, the liquid dispensing system further includes at least one tether, wherein a first end of the at least one tether is attached to the frame, and a second end of the at least one tether is attached to the service cover.

In some aspects, the at least one tether is configured to suspend the service cover in a substantially horizontal position when the service cover is in the open position.

In some aspects, the service cover is removably coupled to the upper portion of the frame.

In some aspects, the filter is a first filter, the liquid dispensing system further includes a second filter supported on the frame.

In some aspects, the liquid dispensing system further includes a basin and a bubbler positioned adjacent the basin, the bubbler configured to dispense liquid into the basin.

In some aspects, the basin includes a first drain for collecting liquid dispensed from the bubbler and a second drain for collecting liquid from the liquid dispensing spigot, the second drain also collecting overflow liquid from the bubbler.

In another independent aspect, a liquid dispensing system includes: a frame; a liquid dispensing spigot supported on the frame; a drain supported on the frame; and at least one filter supported on the frame, the at least one filter positioned in an upper portion of the frame, the filter positioned to provide unobstructed visibility and access to a user while the user is in an upright, standing posture.

In some aspects, the at least one filter is spaced apart from a ground surface by between approximately 27 inches and approximately 72 inches.

In some aspects, the liquid dispensing system further includes a service cover coupled to the frame, the service cover selectively moveable to permit access to the at least one filter.

In some aspects, the filter is a first filter, the liquid dispensing system further includes a second filter.

In some aspects, the liquid dispensing system further includes a basin and a bubbler positioned adjacent the basin, the bubbler configured to dispense liquid into the basin.

In yet another independent aspect, a liquid dispensing system includes a frame; a drain supported on the frame; an alcove positioned on the frame and configured to receive a container; a liquid dispensing spigot positioned in the alcove; and at least one filter supported on the frame, the at least one filter positioned proximate to the alcove, the alcove selectively moveable relative to the frame to permit access to the at least one filter.

In some aspects, a peripheral end of the alcove is coupled to the frame, the alcove pivotable about a rotational axis oriented parallel to an axis extending between an upper end of the frame and a lower end of the frame.

In some aspects, the at least one filter is a first filter, the liquid dispensing system further comprising a second filter supported on the frame and positioned in the lower portion of the frame.

In some aspects, the liquid dispensing system further includes a basin and a bubbler positioned adjacent the basin, the bubbler configured to dispense liquid into the basin.

In still another independent aspect, a liquid dispensing system includes a frame; a drain supported on the frame; an alcove positioned on the frame and configured to receive a container; a liquid dispensing spigot positioned in the alcove; and at least one filter supported on the frame, the at least one filter configured to provide unobstructed visibility of the at least one filter to a user to facilitate access to the filter.

In some aspects, the filter is a first filter, the liquid dispensing system further comprising a second filter positioned proximate to the first filter.

In some aspects, the first filter is selectively configurable to permit staged flow of a liquid through the first filter and the second filter.

In some aspects, the at least one filter is selectively configurable to permit two or more filters to operate independently.

In some aspects, the at least one filter is selectively configurable to permit flow of a liquid through the first filter and a second water treatment device.

In some aspects, the at least one filter is spaced apart from a ground surface by between 27 inches and 72 inches.

In some aspects, the liquid dispensing system further includes a service cover coupled to the frame, the service cover selectively movable to permit access to the at least one filter.

In some aspects, a peripheral end of the service cover is coupled to the upper portion of the frame, the service cover pivotable about a rotational axis oriented parallel to a direction extending laterally between a first side of the frame and a second side of the frame.

In some aspects, the service cover is pivotable about the rotational axis in a direction away from the upper portion of the frame and toward the drain.

In some aspects, the liquid dispensing system further includes at least one tether, wherein a first end of the at least one tether is attached to the frame, and a second end of the at least one tether is attached to the service cover.

In some aspects, the at least one tether is configured to suspend the service cover in a substantially horizontal position when the service cover is in the open position.

In some aspects, the service cover is removably coupled to the upper portion of the frame.

In some aspects, the liquid dispensing system further includes a basin and a bubbler positioned adjacent the basin, the bubbler configured to dispense liquid into the basin.

In some aspects, the basin includes a first drain for collecting liquid dispensed from the bubbler and a second drain for collecting liquid from the liquid dispensing spigot, the second drain also collecting overflow liquid from the bubbler.

### BRIEF DESCRIPTION OF THE DRAWINGS

FIG. 1 is a perspective view of a bottle filler with a service cover in a closed position.

FIG. 2 is a perspective view of the bottle filler of FIG. 1 with the service cover in an open position.

FIG. 3 is an enlarged perspective view of the bottle filler of FIG. 1 with the service cover in an open position.

FIG. 4 is a perspective view of a bottle filler according to another embodiment, with the service cover detached from the frame.

FIG. 5 is a perspective view of a bottle filler according to another embodiment, with a service cover in an open position.

FIG. 6 is a perspective view of a bottle filler according to another embodiment, with a service cover in an open position.

FIG. 7 is an upper perspective view of the bottle filler of FIG. 6.

FIG. 8 is an upper perspective view of a bottle filler according to another embodiment.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” “supported,” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

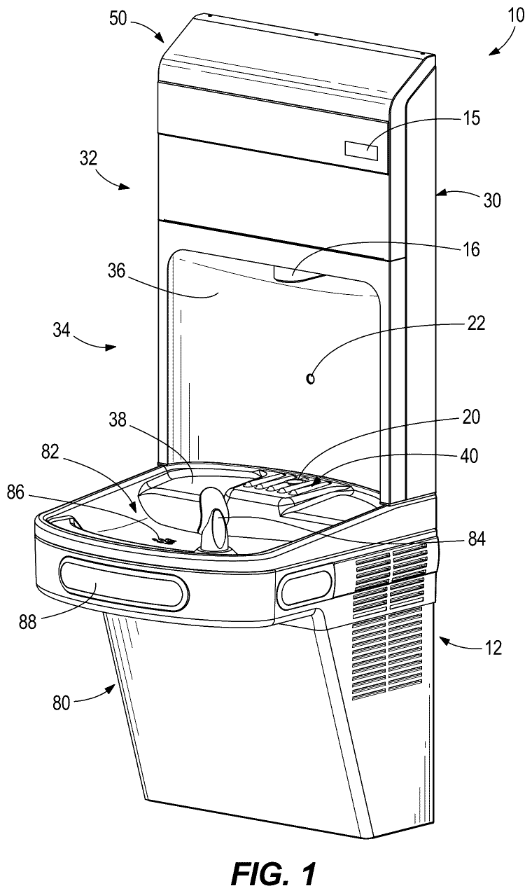

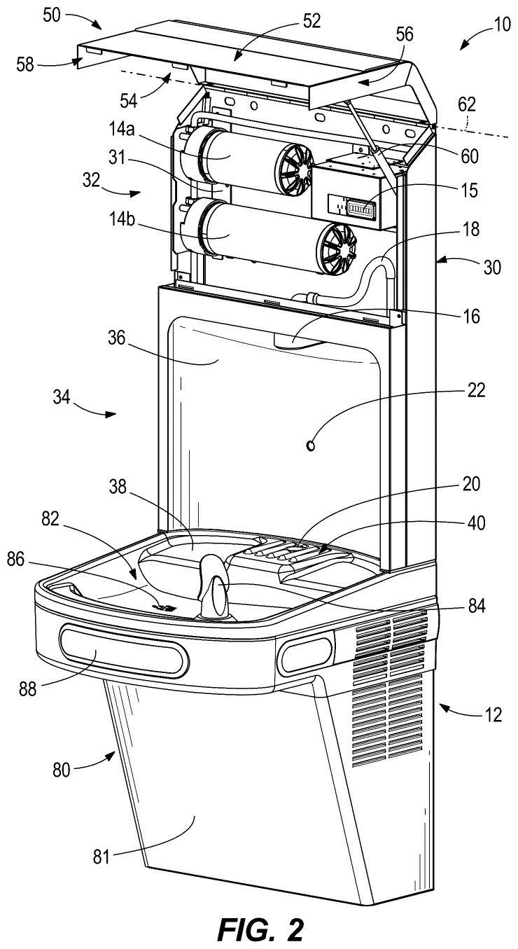

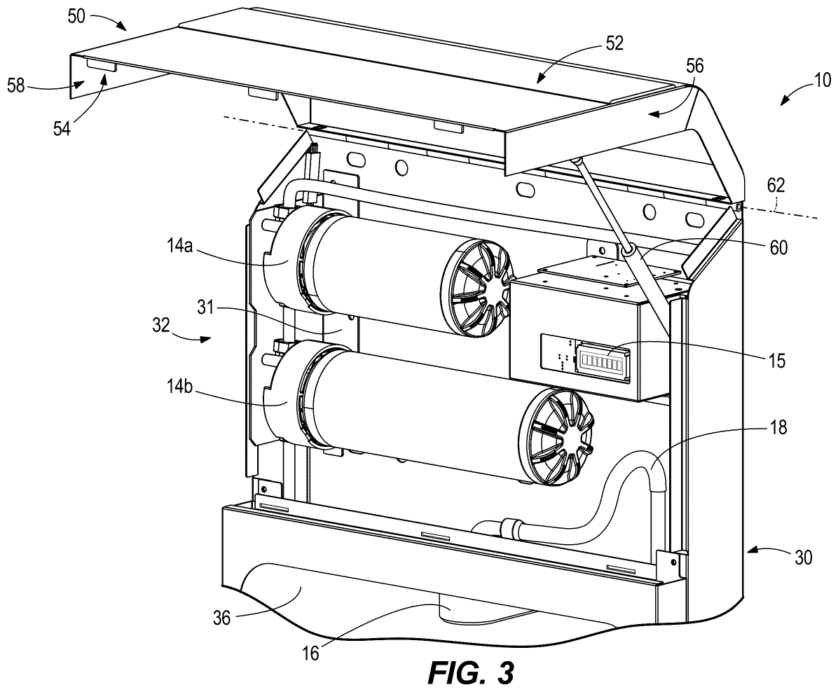

FIGS. 1-3 illustrate a liquid dispensing system (e.g., a bottle filler 10). In some embodiments, the bottle filler 10 may be supported on a wall. The bottle filler 10 may include a housing or frame 30 secured to a support structure (e.g., a wall) and a service cover (e.g., a service panel 50). In some embodiments, the bottler filler 10 is constructed and installed in a manner to be positioned at a standard height relative to a ground surface. In the illustrated embodiment, the bottler filler 10 is constructed to include a drinking fountain 12. For example, the bottle filler 10 may be positioned according to dimensional requirements and specifications for a drinking fountain according to standard regulations (e.g., building codes) and/or legislation (e.g., the Americans with Disabilities Act (ADA)). The service panel 50 may be supported on the frame 30 and may be selectively moveable to permit access to one or more filters 14 (FIG. 2). The bottle filler 10 may also include an alcove 36 and a liquid dispensing spigot 16. The spigot 16 may be connected to a water supply line (e.g., potable water supply). A connection line 18 (FIG. 3) may provide fluid communication with an existing plumbing system. In the illustrated embodiment, the bottle filler 10 further includes a spigot drain 20 for collecting/draining liquid (e.g., basin drain overflow, spills, or inadvertent liquid dispensing). In addition, in the illustrated embodiment, the liquid dispensing system may include a drinking fountain 12 including a base frame 80, a basin 82 supported on the base frame 80, a bubbler 84 positioned adjacent the basin 82, a basin drain 86 positioned at a low point of the basin 82, and an actuator 88. In other embodiments, the system may include only a bottle filler 10 (i.e., the system may omit the bubbler and basin for the drinking fountain).

In some embodiments, as illustrated in FIGS. 2 and 3, the bottle filler 10 includes two filters 14a, 14b supported on the frame 30 (e.g., mounted on the frame 30 via a support bracket 31). The filters 14a, 14b may be positioned to provide a user unobstructed access to the filters 14a, 14b while the user is in an upright, standing posture. For example, in some embodiments, the filter 14 is positioned at a location that is between approximately twenty-seven (27) inches and approximately seventy-two (72) inches above a ground surface. In other embodiments, the filter 14 is positioned such that it provides a user standing height access without requiring the user to bend below a standing height while the at least one filter 14 is mounted on the frame 30. As used herein, the term “standing height” refers to the standing height of a male or female person standing in front of the bottle filler 10. Standing height include a range between a female person in the fifth (5th) percentile for height and a male person in the ninety-fifth (95th) percentile for height. In some embodiments, standing height for a female person in the 5th percentile for height is approximately 56.9 inches, and the standing height for a male person in the 95th percentile for height is approximately 69.8 inches. “Standing height access” refers to providing a user with unobstructed visibility or line-of-sight to the filter and the ability to engage the filter while positioned in an upright, standing position. For purposes of this description, an average eye-level height of a male person is approximately sixty-four (64) inches, and an average eye-level height of a female person is approximately sixty (60) inches.

Unobstructed standing height access to the filter(s) 14 allows for direct, quick, ergonomic, and safe access to facilitate replacement of the filter 14. At least one filter 14 may be positioned such that it does not alter or displace the structure of an existing alcove 36. Such position of the filter(s) 14 avoids installation complications while upgrading from an existing bottle filler 10 to a new bottle filler 10 and facilitates servicing. In the illustrated embodiment, the bottle filler 10 includes multiple water treatment devices.

The filter(s) 14 may be selectively configurable (e.g., by a technician) to provide alternative flow arrangements (e.g., sequential flow filters, independent flow filters, etc.), allowing a user to address different water conditions or particular filtration requirements. For example, a single filter configuration may use a contaminant reduction filter. In a single filter configuration, the second filter location can provide a position for storing a replacement filter, thereby providing easy access and facilitating quick replacement. As another example, as illustrated in FIGS. 2-3, the bottle filler 10 may include a staged flow configuration having a first filter 14a (e.g., a first stage filter) and a second filter 14b (e.g., a second stage filter). In the illustrated embodiment, both filters 14a, 14b may be positioned in an upper portion 32 of the frame 30. The filters 14a, 14b may be arranged sequentially, with water flowing through the first stage filter 14a and then through the second stage filter 14b. For example, the first stage filter 14a may provide a sediment filter, and the second stage filter 14b may be a contaminant reduction filter. In other embodiments, the filter(s) 14 may be arranged for independent flow through each filter, allowing for liquid to be filtered simultaneously through both filter(s) 14. Independent filters may be used when a large contaminant reduction capacity is needed. For example, approximately half of the flow will pass through each independent contaminant reduction filter 14a, 14b before flowing to the filler or bubbler dispense point.

In some embodiments, the bottle filler 10 may be initially configured (e.g., in firmware) for either sequential or independent filtering. Software and/or firmware in a control board may include a table to compare the configuration (e.g., Sequential or Independent) and type of filter installed (sediment reduction, contaminant reduction, etc.) to ensure that the correct filters are installed. In some embodiments, the bottle filler 10 may be reconfigured from Sequential to Independent or vice versa after installation, if desired. Reconfiguration may include modifying the fluid lines leading into and out of the filter(s).

In some embodiments, a second water treatment device may include an ultraviolet treatment device, although other water treatment devices are possible in other embodiments (e.g., high energy anti-microbial radiation (electromagnetic, nuclear, or other)). In other embodiments, the bottle filler 10 may include fewer or more filter(s), and/or the filters may be supported in a different configuration.

In some embodiments, the bottle filler 10 further includes a status display 15, which may be positioned on the upper portion 32 of the frame 30. The status display 15 may notify a user of one or more status or performance metrics (e.g., type of filter, filter capacity, remaining filter life, bottles saved, quantity of water dispensed, purge status, second water treatment device condition, etc.) for one or both filters 14a, 14b or a water treatment device.

In the illustrated embodiment, the spigot 16 is positioned adjacent a lower end of the upper portion 32, and within an upper surface of the alcove 36. In other embodiments, the spigot 16 may be positioned on a different surface of the alcove 36. The connection line 18 may be positioned in the upper portion 32 of the frame 30 and may convey filtered water to the spigot 16 from one or both filters 14a, 14b. In other embodiments, the connection line may be positioned in both the upper portion 32 and the lower portion 34 of the frame 30 to convey filtered water to the spigot 16 and/or the bubbler 84. In some embodiments, the connection line 18 may be a plurality of connection lines that convey filtered water to the spigot 16 and/or bubbler 84. The spigot 16 and connection line 18 may be configured to dispense liquid at a predetermined flow rate.

As shown in FIGS. 1-2, the alcove 36 may be located in a lower portion 34 of the frame 30 and positioned above the drinking fountain 12. A center portion of the alcove 36 may be recessed relative to the sides and upper end of the alcove 36. In some embodiments, the alcove 36 may include one or more planar surfaces. In other embodiments, the alcove 36 may have a curved or arcuate surface. The alcove 36 may include a sensor 22 for controlling dispensing of liquid. In the illustrated embodiment, the sensor 22 is positioned in the center portion of the alcove 36 and below the spigot 16. In other embodiments, the sensor 22 may be located in a side or upper end of the alcove 36 or integral with the spigot 16. In some embodiments, the sensor 22 is an electrical sensor, and the spigot 16 may dispense liquid while a container is detected by the sensor 22 in a position near the spigot 16. In other embodiments, the sensor 22 may be supplemented with or replaced with a mechanical actuator, and the spigot 16 may dispense liquid when the actuator is activated. In other embodiments, the sensor 22 may be supplemented with or replaced with a manual actuator, and the spigot 16 may dispense liquid when a user activates the actuator by hand. Such manual operation allows the user to activate the spigot 16 where the sensor 22 is unable to detect a container or in circumstances where the use of a sensor 22 may not be advisable (e.g., vandal-resistant or outdoor models).

The lower portion 34 of the bottle filler 10 may also include an alcove drain surface 38 supported on the frame 30. The alcove drain surface 38 may be supported on an upper portion of the drinking fountain 12 when installed to provide additional support to the bottle filler 10. In some embodiments, the alcove drain surface 38 may be positioned within the basin 82. The alcove drain surface 38 may include an upper surface or bottle platform 40, which may be located under the spigot 16, to support a container while the spigot 16 dispenses liquid. The alcove drain surface 38 may further include the spigot drain 20 supported on the frame 30 for collecting any liquid (e.g., overflow, spills, or inadvertent liquid dispensing, or plugging of alcove drain). The bottle platform 40 may be a planar surface. In other embodiments, the bottle platform 40 may be a non-planar surface that may engage with a container and/or facilitate drainage of liquid dispensed from the spigot 16. As shown in the illustrated embodiment, the spigot drain 20 may be positioned in the bottle platform 40 of the alcove drain surface 38, but other positions of the spigot drain 20 are possible. In some embodiments, as shown in FIG. 2, the spigot drain 20 may be aligned with the spigot 16. In other embodiments, the alcove drain surface 38 and/or spigot drain 20 may be positioned below an upper edge of the basin 82. In other embodiments, the alcove drain surface 38 and spigot drain 20 may be supported on the frame 30 without a drinking fountain 12.

As best shown in FIG. 3, the service panel 50 is positioned on the upper portion 32 of the frame 30. The service panel 50 may contain a front face 52, a first sidewall 56, a second sidewall 58, and a bottom sidewall 54 extending between the first sidewall 56 and the second sidewall 58. A peripheral end of the service panel 50 may be coupled to the upper portion of the frame 30, and the service panel 50 may be selectively movable to permit access to the filter(s) 14. In one embodiment, the service panel 50 may be pivotable around a rotational axis 62 oriented parallel to a direction extending laterally between a first side of the frame 30 and a second side of the frame 30. The bottle filler 10 may further include a connecting element 60. A first end of the connecting element 60 is attached to the service panel 50, and a second end of the connecting element 60 is attached to the upper portion of the frame 30. The connecting element 60 may control the pivot of the service panel 50 about the rotational axis 62. As best illustrated in FIG. 2, the connecting element 60 may facilitate the suspension and/or stabilization of the service panel 50 when pivoted into an open position.

In some embodiments, the service panel 50 may include a removably coupled user interface panel. The user interface panel may be positioned on the front face 52 of the service panel 50. In some embodiments, when coupled to the service panel 50, the user interface panel may be flush with the front face 52. The user interface panel may provide access to the status display 15, the filter(s) 14, and/or other components without requiring any pivotable movement of the service panel 50. In other embodiments, the status display 15 may be integrated with the user interface panel.

As shown in FIGS. 1-2, the drinking fountain 12 may include a base frame 80 and a basin 82 supported on the base frame 80, wherein the base frame 80 may include a base frame service panel 81. The base frame service panel 81 may be selectively moveable or removable to permit access to elements positioned in the lower portion 34 of the frame 30. In the illustrated embodiment, the basin 82 may be concave towards a center of the basin 82 and may include the basin drain 86 positioned at a low point of the basin 82 and the spigot drain 20 positioned at second location within the basin 82. The position of the spigot drain 20 within the basin 82 serves as an auxiliary drain for collecting excess water dispensed from the bubbler 84 and aids in preventing flooding if the basin drain 86 is obstructed, whether due to clogging or other blockages. The bubbler 84 is positioned adjacent the basin 82 for dispensing liquid. The bubbler 84 may be connected to an existing plumbing system (e.g., potable water supply), and liquid may also pass through one or both filters 14a, 14b prior to being dispensed through the bubbler 84. In some embodiments, the bubbler 84 may include a protective feature such as a shroud or hood for preventing contamination from users, airborne deposits, tampering, etc. The protective feature may be chrome-plated, stainless steel, or another material ideal for heavy use installations (e.g., vandal-resistant or outdoor models). The drinking fountain 12 further includes an actuator 88 (e.g., a push button) configured such that liquid is dispensed from the bubbler 84 while the actuator 88 is activated. The actuator 88 may be activated by a user's manual operation (e.g., a user pressing a push button) to dispense liquid from the bubbler 84, although other methods for activation are possible. Such manual operation of the bubbler 84 may be ideal for heavy use installations or settings (e.g., vandal-resistant or outdoor models).

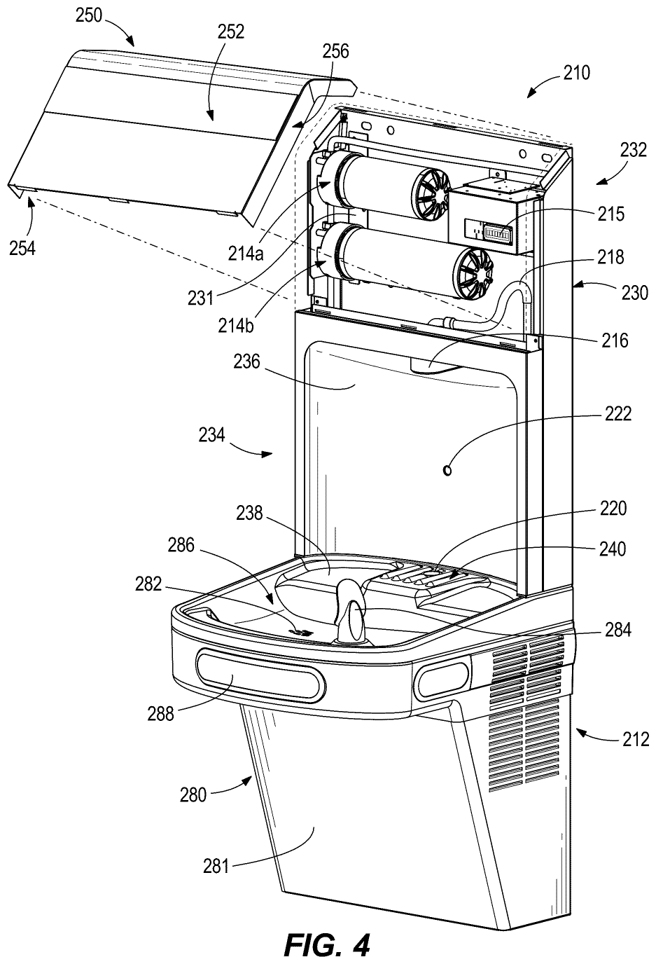

FIG. 4 illustrates a liquid dispensing system (e.g., a bottle filler 210) according to another embodiment. In some embodiments, the bottle filler 210 may be supported on a wall. The bottle filler 210 may include a housing or frame 230 secured to a support structure (e.g., a wall) and a service cover (e.g., a service panel 250). In some embodiments, the bottler filler 210 is constructed and installed in a manner to be positioned at a standard height relative to a ground surface. In the illustrated embodiment, the bottler filler 210 is constructed to include a drinking fountain 212. For example, the bottle filler 210 may be positioned according to dimensional requirements and specifications for a drinking fountain according to standard regulations (e.g., building codes) and/or legislation (e.g., ADA). The service panel 250 may be supported on the frame 230 and may be selectively removable to permit access to one or more filters 214. The bottle filler 210 may also include an alcove 236 and a liquid dispensing spigot 216. The spigot 216 may be connected to a water supply line (e.g., potable water supply). A connection line 218 may provide fluid communication with an existing plumbing system. In the illustrated embodiment, the bottle filler 210 further includes a spigot drain 220 for collecting/draining any liquid (e.g., basin drain overflow, spills, or inadvertent liquid dispensing). In addition, in the illustrated embodiment, the liquid dispensing system further includes a drinking fountain 212 including a base frame 280, a basin 282 supported on the base frame 280, a bubbler 284 positioned adjacent the basin 282, a basin drain 286 positioned at a low point of the basin 282, and an actuator 288. In other embodiments, the system may include only a bottle filler 210 (i.e., the system may omit the bubbler and basin for the drinking fountain).

In some embodiments, as illustrated in FIG. 4, the bottle filler 210 includes two filters 214a, 214b supported on the frame 230 (e.g., mounted on the frame 230 via a support bracket 231). The filters 214a, 214b may be positioned to provide a user unobstructed access to the filters 214a, 214b while the user is in an upright, standing posture. For example, in some embodiments, the at least one filter 214 is positioned between twenty-seven (27) inches and seventy-two (72) inches above a ground surface. In some embodiments, the at least one filter 214 is positioned such that it provides a user standing height access without requiring the user to bend below a standing height while the at least one filter 214 is mounted on the frame 230.

Unobstructed standing height access to the filter(s) 214 allows for direct, quick, ergonomic, and safe access to facilitate replacement of the at least one filter 214. At least one filter 214 may be positioned such that it does not alter or displace the structure of an existing alcove 236. Such position of the filter(s) 214 avoids installation complications while upgrading from an existing bottle filler 210 to a new bottle filler 210 and facilitates servicing. In the illustrated embodiment, the bottle filler 210 includes multiple water treatment devices.

The filter(s) 214 may be selectively configurable (e.g., by a technician) to provide alternative flow arrangements (e.g., sequential flow filters, independent flow filters, etc.), allowing a user to address different water conditions or particular filtration requirements. For example, a single filter configuration may use a contaminant reduction filter. In a single filter configuration, the second filter location can provide a position for storing a replacement filter, thereby providing easy access and facilitating quick replacement. As another example, as illustrated in FIG. 4, the bottle filler 210 may include a staged flow configuration having a first filter 214a (e.g., a first stage filter) and a second filter 214b (e.g., a second stage filter). In the illustrated embodiment, both filters 214a, 214b may be positioned in an upper portion 232 of the frame 230. The filters 214a, 214b may be arranged sequentially, with water flowing through the first stage filter 214a and then through the second stage filter 214b. For example, the first stage filter 214a may provide a sediment filter), and the second stage filter 214b may be a contaminant reduction filter. In other embodiments, the filter(s) 214 may be arranged for independent flow through each filter, allowing for liquid to be filtered simultaneously through both filter(s) 214. Independent filters may be used when a large contaminant reduction capacity is needed. For example, approximately half of the flow will pass through each independent contaminant reduction filter 214a, 214b before flowing to the filler or bubbler dispense point.

In some embodiments, the bottle filler 210 may be initially configured (e.g., in firmware) for either sequential or independent filtering. Software and/or firmware in a control board may include a table to compare the configuration (e.g., Sequential or Independent) and type of filter installed (sediment reduction, contaminant reduction, etc.) to ensure that the correct filters are installed. In some embodiments, the bottle filler 210 may be reconfigured from Sequential to Independent or vice versa after installation, if desired. Reconfiguration may include modifying the fluid lines leading into and out of the filter(s).

In some embodiments, a second water treatment device may include an ultraviolet treatment device, although other water treatment devices are possible in other embodiments (e.g., high energy anti-microbial radiation (electromagnetic, nuclear, or other)). In other embodiments, the bottle filler 210 may include fewer or more filter(s), and/or the filters may be supported in a different configuration.

In some embodiments, the bottle filler 210 further includes a status display 215, which may be positioned on the upper portion 232 of the frame 230. The status display 215 may notify a user of one or more status or performance metrics (e.g., type of filter, filter capacity, remaining filter life, bottles saved, quantity of water dispensed, purge status, second water treatment device condition, etc.) for one or both filters 214a, 214b or a water treatment device.

In the illustrated embodiment, the spigot 216 is positioned adjacent a lower end of the upper portion 232, and within an upper surface of the alcove 236. In other embodiments, the spigot 216 may be positioned on a different surface of the alcove 236. The connection line 218 may be positioned in the upper portion 232 of the frame 230 from an existing plumbing system and may convey filtered water to the spigot 216 from one or both filters 214a, 214b. In other embodiments, the connection line may be positioned in both the upper portion 232 and the lower portion 234 of the frame 230 to convey filtered water to the spigot 216 and/or the bubbler 284. In some embodiments, the connection line 218 may be a plurality of connection lines that convey filtered water to the spigot 216 and/or bubbler 284. The spigot 216 and connection line 218 may be configured to dispense liquid at a predetermined flow rate.

In the illustrated embodiment in FIG. 4, the alcove 236 may be located in a lower portion 234 of the frame 230 and positioned above the drinking fountain 212. A center portion of the alcove 236 may be recessed relative to the sides and upper end of the alcove 236. In some embodiments, the alcove 236 may include one or more planar surfaces. In other embodiments, the alcove 236 may have a curved or arcuate surface. The alcove 236 may include a sensor 222 for controlling dispensing of liquid. In the illustrated embodiment, the sensor 222 is positioned in the center section of the alcove 236 and below the spigot 216. In other embodiments, the sensor 222 may be located in a side or upper end of the alcove 236. The sensor 222 may be an electrical sensor, and the spigot 16 may dispense liquid while a container is detected by the sensor 222 in a position near the spigot 216. In other embodiments, the sensor 222 may be supplemented with or replaced with a mechanical actuator, and the spigot 216 may dispense liquid when the actuator is activated. In other embodiments, the sensor 222 may be supplemented with or replaced with a manual actuator, and the spigot 216 may dispense liquid when a user activates the actuator by hand. Such manual operation allows the user to activate the spigot 216 where the sensor 222 is unable to detect a container or in circumstances where the use of a sensor 222 may not be advisable (e.g., vandal-resistant or outdoor models).

The lower portion 234 of the bottle filler 210 may also include an alcove drain surface 238 supported on the frame 230. The alcove drain surface 238 may be supported on an upper portion of the drinking fountain 212 when installed to provide additional support to the bottle filler 210. In some embodiments, the alcove drain surface 238 may be positioned within the basin 282. The alcove drain surface 238 may include an upper surface or bottle platform 240, which may be located under the spigot 216, to support a bottle while the spigot 216 dispenses liquid. The alcove drain surface 238 may further include a spigot drain 220 supported on the frame 230 for collecting any liquid (e.g., overflow, spills, or inadvertent liquid dispensing, or plugging of alcove drain). The bottle platform 240 may be a planar surface. In other embodiments, the bottle platform 240 may be a non-planar surface that may engage with a container and/or facilitate drainage of liquid dispensed from the spigot 216. As shown in the illustrated embodiment, the spigot drain 220 may be positioned in the bottle platform 240 of the alcove drain surface 238, but other positions of the spigot drain 220 are possible. In some embodiments, as shown in FIG. 4, the spigot drain 220 may be aligned with the spigot 216. In other embodiments, the alcove drain surface 238 and/or spigot drain 220 may be positioned below an upper edge of the basin 282. In other embodiments, the alcove drain surface 238 and spigot drain 220 may be supported on the frame 230 without a drinking fountain 212.

As illustrated in FIG. 4, the service panel 250 is removably coupled to the frame 230. In the illustrated embodiment, the service panel is positioned on the upper portion 232 of the frame 230. The service panel 250 may contain a front face 252, a first sidewall 256, a second sidewall 258, and a bottom sidewall 254 extending between the first sidewall 256 and the second sidewall 258. A peripheral end of the service panel 250 may be coupled to the upper portion of the frame 230, and the service panel 250 may be selectively removable to permit access to the filter(s) 214. The service panel 250 may be positioned in an upper portion 232 of the frame 230 and removably coupled to the upper portion 232 of the frame 230 to permit access to the at least one filter 214.

In some embodiments, the service panel 250 may include a removably coupled user interface panel. The user interface panel may be positioned on the front face 252 of the service panel 250. In some embodiments, when coupled to the service panel 250, the user interface panel may be flush with the front face 252. The user interface panel may provide access to the status display 215, the filter(s) 214, and/or other components without requiring the removal of the service panel 250. In other embodiments, the status display 215 may be integrated with the user interface panel.

As illustrated in FIG. 4, the drinking fountain 212 may include a base frame 280 and a basin 282 supported on the base frame 280, wherein the base frame 280 may include a base frame service panel 281. The base frame service panel 281 may be selectively moveable or removable to permit access to elements positioned in the lower portion 234 of the frame 230. In the illustrated embodiment, the basin 282 may be concave toward a center of the basin 282 and may include a basin drain 286 positioned at a low point of the basin 82 and the spigot drain 220 positioned at second location within the basin 282. The position of the spigot drain 220 within the basin 282 serves as an auxiliary drain for collecting excess water dispensed from the bubbler 284 and aids in preventing flooding if the basin drain 286 is obstructed, whether due to clogging or other blockages. The bubbler 284 is positioned adjacent the basin 282 for dispensing liquid. The bubbler 284 may be connected to an existing plumbing system (e.g., potable water supply), and liquid may also pass through one or both filters 214a, 214b prior to being dispensed through the bubbler 284. In some embodiments, the bubbler 284 may include a protective feature such as a shroud or hood for preventing contamination from users, airborne deposits, tampering, etc. The protective feature may be chrome-plated, stainless steel, or another material ideal for heavy use installations (e.g., vandal-resistant or outdoor models). The drinking fountain 212 further includes an actuator 288 (e.g. a push button) configured liquid is dispensed from the bubbler 284 while the actuator 288 is activated. The actuator 288 may be activated by a user's manual operation (e.g., a user pressing a push button) to dispense liquid from the bubbler 284, although other methods for activation are possible. Such manual operation of the bubbler 284 may be ideal for heavy use installations or settings (e.g., vandal-resistant or outdoor models).

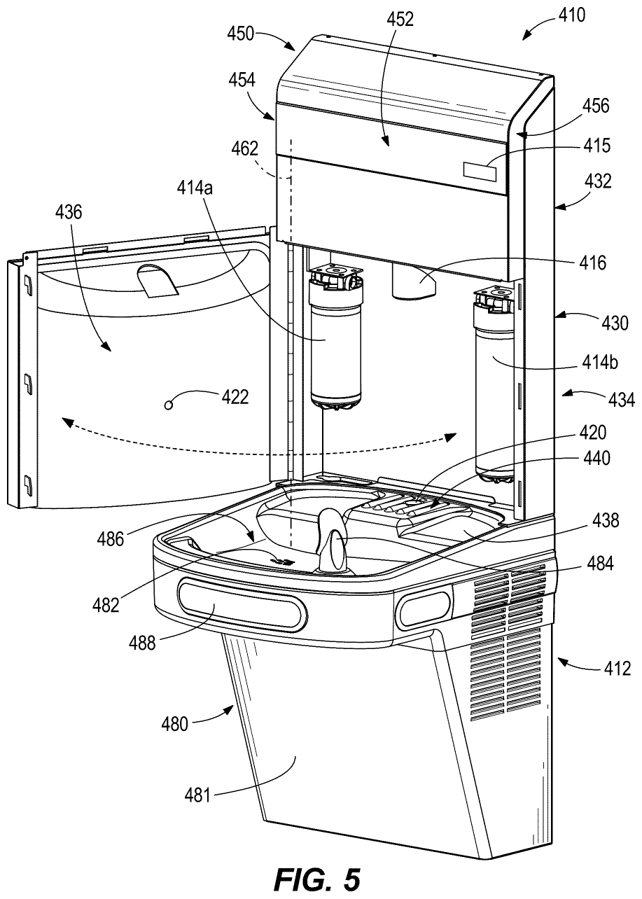

FIG. 5 illustrates a liquid dispensing system (e.g., a bottle filler 410) according to another embodiment. In some embodiments, the bottle filler 410 may be supported on a wall. The bottle filler 410 may include a frame 430 secured to a support structure (e.g., a wall). In some embodiments, the bottler filler 410 is constructed and installed in a manner to be positioned at a standard height relative to a ground surface. In some embodiments, the bottler filler 410 is constructed to include a drinking fountain 412. For example, the bottle filler 10 may be positioned according to dimensional requirements and specifications for a drinking fountain according to standard regulations (e.g., building codes) and/or legislation (e.g., the Americans with Disabilities Act (ADA)). As illustrated in FIG. 5, the upper portion 432 of the frame 430 may include a front face 452, a first sidewall 454, and a second sidewall 456. The bottle filler 410 may also include an alcove 436 and a liquid dispensing spigot 416 positioned in the alcove 436. The spigot 416 may be connected to a water supply line (e.g., potable water supply). A connection line (not shown) may provide fluid communication from an existing plumbing system. The spigot 416 may be configured to dispense liquid at a predetermined flow rate. In other embodiments, the system may include only a bottle filler 410 (i.e., the system may omit the bubbler and basin for the drinking fountain).

In some embodiments, the service panel 450 may include a removably coupled user interface panel. The user interface panel may be positioned on the front face 452 of the service panel 450. In some embodiments, when coupled to the service panel 450, the user interface panel may be flush with the front face 452. The user interface panel may provide access to the status display 415, the filter(s) 414, and/or other components without requiring any pivotable movement of the service panel 450. In other embodiments, the status display 415 may be integrated with the user interface panel.

In some embodiments, the bottle filler 410 includes one or more filters 414 supported on the frame 430 (e.g., mounted on the frame 430 via a support bracket, not pictured). The filter(s) 414 may be positioned to provide a user unobstructed access to the filter(s) 414 while the alcove 436 is pivoted to an open position. In some embodiments, the at least one filter 414 is positioned such that it provides the user standing height access without requiring the user to bend below a standing height while the at least one filter 414 is mounted on the frame 430.

Unobstructed access to the filter(s) 414 (e.g., while the alcove 436 is pivoted) allows for direct, quick, ergonomic, and safe access to facilitate replacement of the filter(s) 414. In some embodiments, the filter(s) 414 is positioned such that it does not alter or displace the structure of an existing alcove 436. Such position of the filter(s) 414 avoids installation complications while upgrading from an existing bottler filler 410 to a new bottle filler 410 and facilitates servicing. In the illustrated embodiment, the bottle filler 410 includes multiple water treatment devices.

The filter(s) 414 may be selectively configurable (e.g., by a technician) to provide alternative flow arrangements (e.g., sequential flow filters, independent flow filters, etc.), allowing a user to address different water conditions or particular filtration requirements. For example, a single filter configuration may use a contaminant reduction filter. In a single filter configuration, the second filter location can provide a position for storing a replacement filter, thereby providing easy access and facilitating quick replacement. As another example, the bottle filler 410 may include a staged flow configuration having a first filter 414a (e.g., a first stage filter) and a second filter 414b (e.g., a second stage filter). In the illustrated embodiment, both filters 414a, 414b may be positioned in an upper portion 432 of the frame 430. The filters 414a, 414b may be arranged sequentially, with water flowing through the first stage filter 14a and then through the second stage filter 414b. For example, the first stage filter 414a may provide a sediment filter, and the second stage filter 414b may be a contaminant reduction filter. In other embodiments, the filter(s) 414 may be arranged for independent flow through each filter, allowing for liquid to be filtered simultaneously through both filter(s) 414. Independent filters may be used when a large contaminant reduction capacity is needed. For example, approximately half of the flow will pass through each independent contaminant reduction filter 414a, 414b before flowing to the filler or bubbler dispense point.

In some embodiments, the bottle filler 410 may be initially configured (e.g., in firmware) for either sequential or independent filtering. Software and/or firmware in a control board may include a table to compare the configuration (e.g., Sequential or Independent) and type of filter installed (sediment reduction, contaminant reduction, etc.) to ensure that the correct filters are installed. In some embodiments, the bottle filler 410 may be reconfigured from Sequential to Independent or vice versa after installation, if desired. Reconfiguration may include modifying the fluid lines leading into and out of the filter(s).

In some embodiments, a second water treatment device may include an ultraviolet treatment device, although other water treatment devices are possible in other embodiments (e.g., high energy anti-microbial radiation (electromagnetic, nuclear, or other)). In other embodiments, the bottle filler 410 may include fewer or more filter(s), and/or the filters may be supported in a different configuration.

In some embodiments, the bottle filler 410 further includes a status display 415, which may be positioned on the upper portion 432 of the frame 430. The status display 415 is configured to notify a user of one or more status/performance metrics (e.g., type of filter, filter capacity, remaining filter life, bottles saved, quantity of water dispensed, purge status, second water treatment device condition, etc.) for one or both filters 414a, 414b or a water treatment device.

As shown in FIG. 5, the alcove 436 may be supported for pivoting movement relative to the frame 430 to selectively permit access to the filter(s) 414. In one embodiment, one side or peripheral end of the alcove 436 is coupled to the frame 430, and the alcove 436 is pivotable about a rotational axis 462 oriented in a vertical direction relative to the alcove 436. In other embodiments, the alcove 436 is removable. The alcove 436 may be located in a lower portion 434 of the frame 430 and positioned above the drinking fountain 412. A center portion of the alcove 436 may be recessed relative to the sides and upper end of the alcove 436. In some embodiments, the alcove 436 may include one or more planar surfaces. In other embodiments, the alcove 436 may have a curved or arcuate surface. In the illustrated embodiment, the filters 414a, 414b are positioned on opposite sides of the alcove 436, such that the recessed center portion is positioned between the filters 414a, 414b while the alcove is closed (i.e., in the operating position). The alcove 436 may include a sensor 422 for controlling dispensing of liquid. In the illustrated embodiment, the sensor 422 is positioned in the center section of the alcove 436 and below the spigot 416. In other embodiments, the sensor 422 may be located in a side or upper end of the alcove 436. The sensor 422 may be an electrical sensor, where the connection line 418 is actuated to dispense liquid through the spigot 416 when a container is detected by the sensor 422 in a position near the spigot 416. In other embodiments, the sensor 422 may be supplemented with or replaced with a mechanical actuator, and the spigot 416 may dispense liquid when the actuator is activated. In other embodiments, the sensor 422 may be supplemented with or replaced with a manual actuator, and the spigot 416 may dispense liquid when a user activates the actuator by hand. Such manual operation allows the user to activate the spigot 416 where the sensor 422 is unable to detect a container or in circumstances where the use of a sensor 422 may not be advisable (e.g., vandal-resistant or outdoor models).

The lower portion 434 of the bottle filler 410 may also include an alcove drain surface 438 supported on the frame 430. The alcove drain surface 438 may be supported on an upper portion of the drinking fountain 412 when installed to provide additional support to the bottle filler 410. In some embodiments, the alcove drain surface may be positioned within the basin 482. The alcove drain surface 438 may include an upper surface or bottle platform 440, which may be located under the spigot 416, to support a container while the spigot 416 dispenses liquid. The alcove drain surface 438 may further include a spigot drain 420 supported on the frame 430 for collecting any liquid (e.g., overflow, spills, or inadvertent liquid dispensing, or plugging of the alcove drain). The bottle platform 440 may be a planar surface. In other embodiments, the bottle platform 440 may be a non-planar surface that may engage with a container and/or facilitate drainage of liquid dispensed from the spigot 16. As shown in the illustrated embodiment, the spigot drain 420 may be positioned in the bottle platform 440 of the alcove drain surface 438, but other positions of the spigot drain 420 are possible. In some embodiments, as shown in FIG. 5, the spigot drain 420 may be aligned with the spigot 416. In other embodiments, the alcove drain surface 438 and/or spigot drain 420 may be positioned below an upper edge of the basin 482. In other embodiments, the alcove drain surface 438 and spigot drain 420 may be supported on the frame 430 without a drinking fountain 412.

In addition, as shown in FIG. 5, the drinking fountain 412 includes a base frame 480 and a basin 482 supported on the base frame 480, wherein the base frame 480 may contain a base frame service panel 481. The base frame service panel may be selectively moveable or removable to permit access to elements positioned in the lower portion 434 of the frame 430. In the illustrated embodiment, the basin 482 is concave toward a center of the basin 482 and includes a basin drain 486 positioned at a low point of the basin 482 and the spigot drain 420 positioned at second location within the basin 482. The position of the spigot drain 420 within the basin 482 serves as an auxiliary drain for collecting excess water dispensed from the bubbler 484 and aids in preventing flooding if the basin drain 486 is obstructed, whether due to clogging or other blockages. The bubbler 484 is positioned adjacent the basin 482 for dispensing liquid and is positioned at a distance from the alcove 436 to avoid interfering with the pivoting movement of the alcove 436. The bubbler 484 may be connected to an existing plumbing system (e.g., potable water supply), and liquid may also pass through one or both filters 414a, 414b prior to being dispensed through the bubbler 484. In some embodiments, the bubbler 484 may include a protective feature such as a shroud or hood for preventing contamination from users, airborne deposits, tampering, etc. The protective feature may be chrome-plated, stainless steel, or another material ideal for heavy use installations (e.g., vandal-resistant or outdoor models). The drinking fountain 412 further includes an actuator 488 (e.g. a push button) configured such that liquid is dispensed from the bubbler 484 while the push button 488 is pressed. The actuator 488 may be activated by a user's manual operation (e.g., a user pressing a push button) to dispense liquid from the bubbler 484, although other methods for activation are possible. Such manual operation of the bubbler 484 may be ideal for heavy use installations or settings (e.g., vandal-resistant or outdoor models). In other embodiments, the system may include only a bottle filler 410.

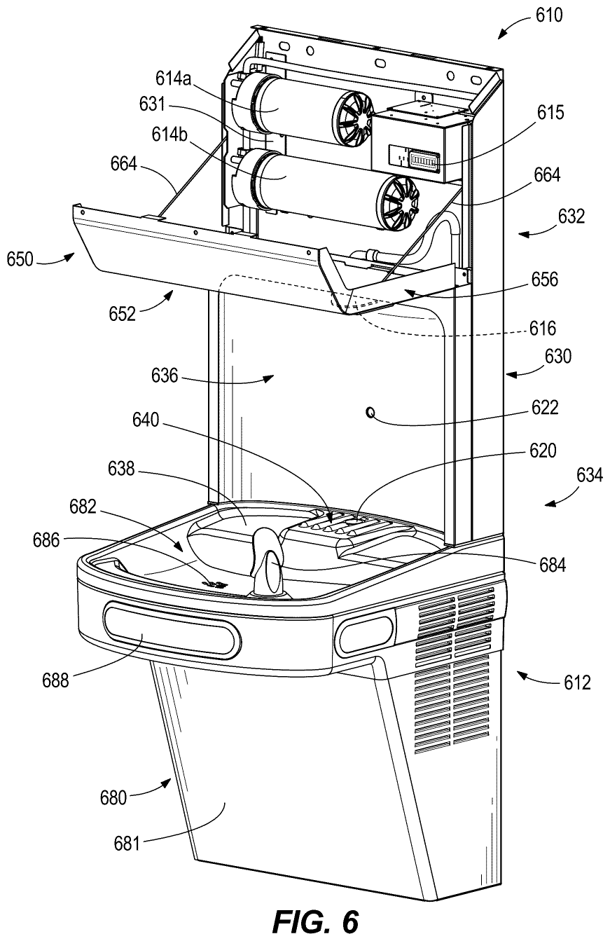

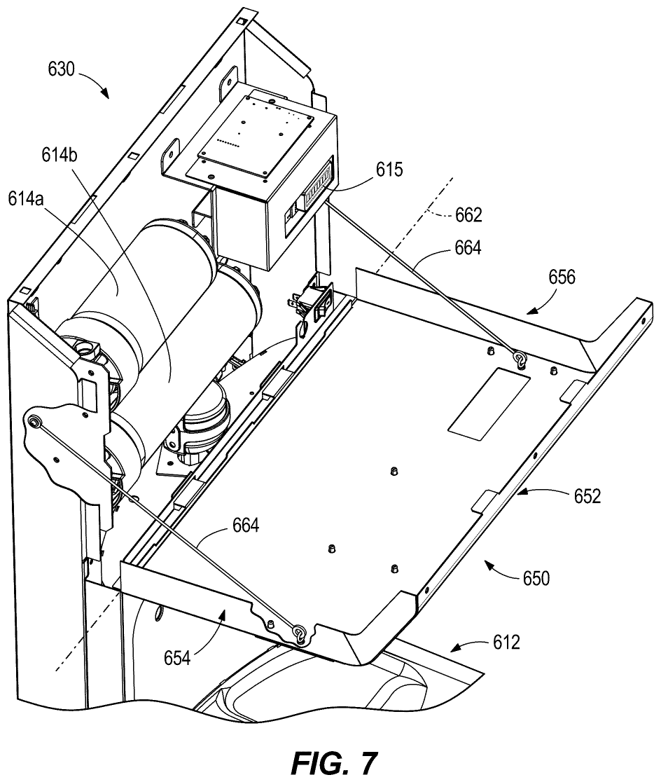

FIGS. 6 and 7 illustrate a liquid dispensing system (e.g., a bottle filler 610) according to yet another embodiment. In some embodiments, the bottle filler 610 may be supported on a wall. The bottle filler 610 may include a housing or frame 630 secured to a support structure (e.g., a wall) and a service cover (e.g., a service panel 650). In some embodiments, the bottler filler 610 is constructed and installed in a manner to be positioned at a standard height relative to a ground surface. In the illustrated embodiment, the bottler filler 610 is constructed to include a drinking fountain 612. For example, the bottle filler 610 may be positioned according to dimensional requirements and specifications for a drinking fountain according to standard regulations (e.g., building codes) and/or legislation (e.g., the Americans with Disabilities Act (ADA)). The service panel 650 may be supported on the frame 630 and may be selectively moveable or removable to permit access to one or more filters 614 (FIG. 7). The bottle filler 610 may also include an alcove 636 and a liquid dispensing spigot 616. The spigot 616 may be connected to a water supply line (e.g., potable water supply). A connection line 618 (FIG. 6) may provide fluid communication with an existing plumbing system. In the illustrated embodiment, the bottle filler 610 further includes a spigot drain 620 for collecting/draining liquid (e.g., basin drain overflow, spills, or inadvertent liquid dispensing). In addition, in the illustrated embodiment, the liquid dispensing system may include a drinking fountain 612 including a base frame 680, a basin 682 supported on the base frame 680, a bubbler 684 positioned adjacent the basin 682, a basin drain 686 positioned at a low point of the basin 682, and an actuator 688. In other embodiments, the system may include only a bottle filler 610 (i.e., the system may omit the bubbler and basin for the drinking fountain).

In some embodiments, as illustrated in FIGS. 6-7, the bottle filler 610 includes two filters 614a, 614b supported on the frame 630 (e.g., mounted on the frame 630 via a support bracket 631). The filters 14a, 14b may be positioned to provide a user unobstructed access to the filters 14a, 14b while the user is in an upright, standing posture. For example, the filter(s) 614 is positioned at a location that is between approximately twenty-seven (27) inches and approximately seventy-two (72) inches above a ground surface. In other embodiments, the filter(s) 614 is positioned such that it provides a user standing height access without requiring the user to bend below a standing height while the at least one filter 614 is mounted on the frame 630.

Unobstructed standing height access to the filter(s) 614 allows for direct, quick, ergonomic, and safe access to facilitate replacement of the filter 614. In some embodiments, the filter(s) 614 are positioned such that it does not alter or displace the structure of an existing alcove 636. Such filter positioning avoids installation complications while upgrading from an existing bottle filler 610 to a new bottle filler 610 and facilitates servicing. In the illustrated embodiment, the bottle filler 610 includes multiple water treatment devices.

The filter(s) 614 may be selectively configurable (e.g., by a technician) to provide alternative flow arrangements (e.g., sequential flow filters, independent flow filters, etc.), allowing a user to address different water conditions or particular filtration requirements. For example, a single filter configuration may use a contaminant reduction filter. In a single filter configuration, the second filter location can provide a position for storing a replacement filter, thereby providing easy access and facilitating quick replacement. As another example, as illustrated in FIGS. 6-7, the bottle filler 610 may include a staged flow configuration having a first filter 614a (e.g., a first stage filter) and a second filter 614b (e.g., a second stage filter). In the illustrated embodiment, both filters 614a, 614b may be positioned in an upper portion 632 of the frame 630. The filters 614a, 614b may be arranged sequentially, with water flowing through the first stage filter 614a and then through the second stage filter 614b. For example, the first stage filter 614a may provide a sediment filter, and the second stage filter 614b may be a contaminant reduction filter. In other embodiments, the filter(s) 614 may be arranged for independent flow through each filter, allowing for liquid to be filtered simultaneously through both filter(s) 614. Independent filters may be used when a large contaminant reduction capacity is needed. For example, approximately half of the flow will pass through each independent contaminant reduction filter 614a, 614b before flowing to the filler or bubbler dispense point.

In some embodiments, the bottle filler 610 may be initially configured (e.g., in firmware) for either sequential or independent filtering. Software and/or firmware in a control board may include a table to compare the configuration (e.g., Sequential or Independent) and type of filter installed (sediment reduction, contaminant reduction, etc.) to ensure that the correct filters are installed. In some embodiments, the bottle filler 610 may be reconfigured from Sequential to Independent or vice versa after installation, if desired. Reconfiguration may include modifying the fluid lines leading into and out of the filter(s).

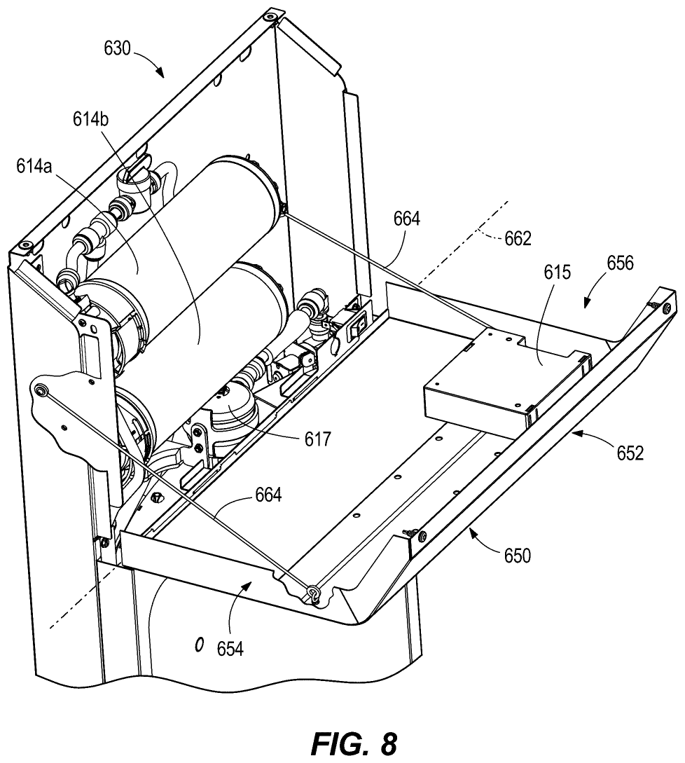

In some embodiments, the bottle filler 610 may include a second water treatment device. As illustrated in FIG. 8, the second water treatment device may be an ultraviolet treatment device 617 designed to disrupt or remove various forms of microbiological contamination, although other water treatment devices are possible in other embodiments (e.g., high energy anti-microbial radiation (electromagnetic, nuclear, or other)). The ultraviolet treatment device 617 may be supported on the frame 630 and may be positioned to provide a user unobstructed access to the ultraviolet treatment device 617 while the user is in an upright, standing posture. In some embodiments, the ultraviolet treatment device 617 may be selectively configurable in combination with the filter(s) 614 to provide alternative flow arrangements, while in other embodiments, the ultraviolet treatment device 617 may operate independently of the filters 614. In other embodiments, the bottle filler 610 may include fewer or more filter(s), and/or the filters may be supported in a different configuration.

In some embodiments, the bottle filler 610 further includes a status display 615, which may be positioned on the upper portion 632 of the frame 630. The status display 615 is may notify a user of one or more status or performance metrics (e.g., type of filter, filter capacity, remaining filter life, bottles saved, quantity of water dispensed, purge status, second water treatment device condition, etc.) for one or both filters 614a, 614b or a water treatment device. In other embodiments, as shown in the embodiment illustrated in FIG. 8, the status display 615 may be positioned on the service panel 650. Such position of the status display 615 on the service panel 650 allows for alternative access to the mechanical components of the status display 615 when the service panel 650 is pivoted to the open position to facilitate servicing of the status display 615.

In the illustrated embodiment, the spigot 616 is positioned adjacent a lower end of the upper portion 632, and within an upper surface of the alcove 636. In other embodiments, the spigot 616 may be positioned on a different surface of the alcove 636. The connection line 618 may be positioned in the upper portion 632 of the frame 630 and may convey filtered water to the spigot 616 or bubbler 684 from one or both filters 614a, 614b. In other embodiments, the connection line may be positioned in both the upper portion 632 and the lower portion 634 of the frame 630 to convey filtered water to the spigot 616 and/or the bubbler 684. In some embodiments, the connection line 618 may be a plurality of connection lines that convey filtered water to the spigot 616 and/or bubbler 684. The spigot 616 and connection line 618 may be configured to dispense liquid at a predetermined flow rate.

As shown in FIG. 6, the alcove 636 may be located in a lower portion 634 of the frame 630 and positioned above the drinking fountain 612. A center portion of the alcove 636 may be recessed relative to the sides and upper end of the alcove 636. In some embodiments, the alcove 636 may include one or more planar surfaces. In other embodiments, the alcove 636 may have a curved or arcuate surface. The alcove 636 may include a sensor 622 for controlling dispensing of liquid. In the illustrated embodiment, the sensor 622 is positioned in the center portion of the alcove 636 and below the spigot 616. In other embodiments, the sensor 622 may be located in a side or upper end of the alcove 636 or integral with the spigot 616. In some embodiments, the sensor 622 is an electrical sensor, and the spigot 616 may dispense liquid while a container is detected by the sensor 622 in a position near the spigot 616. In other embodiments, the sensor 622 may be supplemented with or replaced with a mechanical actuator, and the spigot 616 may dispense liquid when the actuator is activated. In other embodiments, the sensor 622 may be supplemented with or replaced with a manual actuator, and the spigot 616 may dispense liquid when a user activates the actuator by hand. Such manual operation allows the user to activate the spigot 616 where the sensor 622 is unable to detect a container or in circumstances where the use of a sensor 622 may not be advisable (e.g., vandal-resistant or outdoor models).

The lower portion 634 of the bottle filler 610 may also include an alcove drain surface 638 supported on the frame 630. The alcove drain surface 638 may be supported on an upper portion of the drinking fountain 612 when installed to provide additional support to the bottle filler 610. In some embodiments, the alcove drain surface may be positioned within the basin 682. The alcove drain surface 638 may include an upper surface or bottle platform 640, which may be located under the spigot 616, to support a container while the spigot 616 dispenses liquid. The alcove drain surface 638 may further include the spigot drain 620 supported on the frame 630 for collecting any liquid (e.g., overflow, spills, or inadvertent liquid dispensing, or plugging of alcove drain). The bottle platform 640 may be a planar surface. In other embodiments, the bottle platform 640 may be a non-planar surface that may engage with a container and/or facilitate drainage of liquid dispensed from the spigot 616. As shown in the illustrated embodiment, the spigot drain 620 may be positioned in the bottle platform 640 of the alcove drain surface 638, but other positions of the spigot drain 620 are possible. In some embodiments, as shown in FIG. 7, the spigot drain 620 may be aligned with the spigot 616. In other embodiments, the alcove drain surface 638 and/or spigot drain 620 may be positioned below an upper edge of the basin 682. In other embodiments, the alcove drain surface 638 and spigot drain 620 may be supported on the frame 630 without a drinking fountain 612.

As best shown in FIG. 7, the service panel 650 is positioned on the upper portion 632 of the frame 630. The service panel 650 may contain a front face 652. In some embodiments, the service panel 650 also includes a first sidewall 654 and a second sidewall 656. One end (e.g., a lower end) of the service panel 50 may be coupled to the upper portion 632 of the frame 630, and the service panel 650 is selectively movable to permit access to an interior compartment in which the filter(s) 614 are positioned. In one embodiment, the service panel 650 may be pivotable around a rotational axis 662 oriented parallel to a direction extending laterally between a first side of the frame 630 and a second side of the frame 630. In the illustrated embodiment, the service panel 650 rotates in a direction away from an upper end of the bottle filler 610 in order to provide access to the interior compartment.

In some embodiments, the service panel 650 may include a removably coupled user interface panel. The user interface panel may be positioned on the front face 652 of the service panel 650. In some embodiments, when coupled to the service panel 650, the user interface panel may be flush with the front face 652. The user interface panel may provide access to the status display 615, the filter(s) 614, and/or other components without requiring any pivotable movement of the service panel 650. In other embodiments, the status display 615 may be integrated with the user interface panel.

The bottle filler 610 may further include one or more tethers 664. A first end of each tether 664 may be attached to the service panel 650, and a second end of each tether 664 may be attached to the upper portion of the frame 630. The tether(s) 664 control (e.g., limit) the pivoting movement of the service panel 650 about the rotational axis 662. As best illustrated in FIG. 7, the tether(s) 664 may assist in the suspension and/or stabilization of the service panel 650 when pivoted into an open position. While in the open position, the service panel 650 may be positioned in a substantially horizontal orientation (FIG. 7), and the service panel 650 may be used for temporary placement of articles (e.g., tools, parts, used filter(s), new filter(s), etc.) while a technician is performing maintenance on the bottle filler 610 or accessing the filter(s) 614 (e.g., a technician may place a new filter 614 on the service panel 650 while uninstalling an existing filter 614, and may place the removed filter on the service panel 650 while installing the new filter 614). The tether(s) 664 may provide support strength while a user utilizes the service panel 650 as a support shelf. In some embodiments, as shown in FIGS. 6-7, the bottle filler 610 may include two tethers 664 positioned on peripheral sides of the frame 630, although other embodiments are possible. In other embodiments, the service panel may be supported in an open position in another manner.

As shown in FIG. 6, the drinking fountain 612 may include a base frame 680 and a basin 682 supported on the base frame 680, wherein the base frame 680 may include a base frame service panel 681. The base frame service panel 681 may be selectively moveable or removable to permit access to elements positioned in the lower portion 634 of the frame 630. In the illustrated embodiment, the basin 682 may be concave towards a center of the basin 682 and may include the basin drain 686 positioned at a low point of the basin 682 and the spigot drain 620 positioned at second location within the basin 682. The position of the spigot drain 620 within the basin 682 serves as an auxiliary drain for collecting excess water dispensed from the bubbler 684 and aids in preventing flooding if the basin drain 686 is obstructed, whether due to clogging or other blockages. The bubbler 684 is positioned adjacent the basin 682 for dispensing liquid. The bubbler 684 may be connected to an existing plumbing system (e.g., potable water supply), and liquid may also pass through one or both filters 614a, 614b prior to being dispensed through the bubbler 684. In some embodiments, the bubbler 684 may include a protective feature such as a shroud or hood for preventing contamination from users, airborne deposits, tampering, etc. The protective feature may be chrome-plated, stainless steel, or another material ideal for heavy use installations (e.g., vandal-resistant or outdoor models). The drinking fountain 612 further includes an actuator 688 (e.g., a push button) configured such that liquid is dispensed from the bubbler 84 while the actuator 88 is activated. The actuator 688 may be activated by a user's manual operation (e.g., a user pressing a push button) to dispense liquid from the bubbler 684, although other methods for activation are possible. Such manual operation of the bubbler 684 may be ideal for heavy use installations or settings (e.g., vandal-resistant or outdoor models).

The embodiment(s) described above and illustrated in the figures are presented by way of example only and are not intended as a limitation upon the concepts and principles of the present disclosure. It will be understood that certain features and sub combinations are of utility and may be employed without reference to other features and sub combinations. Features described and illustrated with respect to certain embodiments may also be implemented in other embodiments. This is contemplated by and is within the scope of the claims. Since many possible embodiments of the disclosure may be made without departing from the scope thereof, it is also to be understood that all matters herein set forth or shown in the accompanying drawings are to be interpreted as illustrative and not limiting. As such, it will be appreciated that variations and modifications to the elements and their configuration and/or arrangement exist within the spirit and scope of one or more independent aspects as described.

1. A liquid dispensing system comprising:
a frame;
a liquid dispensing spigot supported on the frame;
a drain supported on the frame; and
at least one filter supported on the frame, the at least one filter positioned in an upper portion of the frame and configured to provide unobstructed visibility of the at least one filter to a user to facilitate access to the filter.

2. The liquid dispensing system of claim 1, wherein the at least one filter is spaced apart from a ground surface by between 27 inches and 72 inches.

3. The liquid dispensing system of claim 1, further comprising a service cover coupled to the frame, the service cover selectively movable to permit access to the at least one filter.

4. The liquid dispensing system of claim 3, wherein a peripheral end of the service cover is coupled to the upper portion of the frame, the service cover pivotable about a rotational axis oriented parallel to a direction extending laterally between a first side of the frame and a second side of the frame.

5. The liquid dispensing system of claim 4, the service cover being pivotable about the rotational axis in a direction away from the upper portion of the frame and toward the drain.

6. The liquid dispensing system of claim 5, further comprising at least one tether, wherein a first end of the at least one tether is attached to the frame, and a second end of the at least one tether is attached to the service cover.

7. The liquid dispensing system of claim 6, wherein the at least one tether is configured to suspend the service cover in a substantially horizontal position when the service cover is in the open position.

8. The liquid dispensing system of claim 3, wherein the service cover is removably coupled to the upper portion of the frame.

9. The liquid dispensing system of claim 1, wherein the filter is a first filter, the liquid dispensing system further comprising a second filter supported on the frame.

10. The liquid dispensing system of claim 1, further comprising a basin and a bubbler positioned adjacent the basin, the bubbler configured to dispense liquid into the basin.

11. The liquid dispensing system of claim 10, wherein the basin includes a first drain for collecting liquid dispensed from the bubbler and a second drain for collecting liquid from the liquid dispensing spigot, the second drain also collecting overflow liquid from the bubbler.

12. A liquid dispensing system comprising:
a frame;
a liquid dispensing spigot supported on the frame;
a drain supported on the frame; and
at least one filter supported on the frame, the at least one filter positioned in an upper portion of the frame, the filter positioned to provide unobstructed visibility and access to a user while the user is in an upright, standing posture.

13. The liquid dispensing system of claim 12, wherein the at least one filter is spaced apart from a ground surface by between 27 inches and 72 inches.

14. The liquid dispensing system of claim 12, further comprising a service cover coupled to the frame, the service cover selectively moveable to permit access to the at least one filter.

15. The liquid dispensing system of claim 12, wherein the filter is a first filter, the liquid dispensing system further comprising a second filter.

16. The liquid dispensing system of claim 12, further comprising a basin and a bubbler positioned adjacent the basin, the bubbler configured to dispense liquid into the basin.

17. A liquid dispensing system comprising:
a frame;
a drain supported on the frame;
an alcove positioned on the frame and configured to receive a container;
a liquid dispensing spigot positioned in the alcove; and
at least one filter supported on the frame, the at least one filter positioned proximate to the alcove, the alcove selectively moveable relative to the frame to permit access to the at least one filter.

18. The liquid dispensing system of claim 17, wherein a peripheral end of the alcove is coupled to the frame, the alcove pivotable about a rotational axis oriented parallel to an axis extending between an upper end of the frame and a lower end of the frame.

19. The liquid dispensing system of claim 17, wherein the at least one filter is a first filter, the liquid dispensing system further comprising a second filter supported on the frame and positioned in the lower portion of the frame.

20. The liquid dispensing system of claim 17, further comprising a basin and a bubbler positioned adjacent the basin, the bubbler configured to dispense liquid into the basin.

21-34. (canceled)
